(19) United States
(12) Patent Application Publication
(10) Pub. No.: US 2011/0231794 A1
(43) Pub. Date: Sep. 22, 2011

(54) Method and System for Retrieval of Instant Messenger History

(75) Inventor: Yury Alexandrovich Gubanov, St. Petersburg (RU)

(73) Assignee: Yury Alexandrovich Gubanov, Cary, NC (US)

(21) Appl. No.: 12/727,891

(22) Filed: Mar. 19, 2010

(51) Int. Cl. G06F 17/30; G06F 3/048

(52) U.S. Cl. 715/810; 707/758; 707/E17.014

(57) ABSTRACT

Method and system for retrieval of Instant Messenger history from a computer, in the absence of the Instant Messenger program or user login information. Files containing messages are discovered by file names, folder structure or content patterns. Files can be discovered on a storage device, in an archive or image file or in the Recycle Bin. Messages may be discovered from file fragments or copies of active RAM memory by using patterns in their content. Messages are presented to an investigator sorted by various criteria, such as Instant Messenger program, chat participants and message timestamps.

### FIELD OF INVENTION

This invention relates to a method and system for retrieving messages sent and received from a computer device by a user who employed an instant messenger program. The messages are retrieved and displayed on criteria like sender, recipient, instant messenger program used and time of transmittal. The list of instant message products may include, but is not limited to, Skype, ICQ, Yahoo! Messenger, Miranda, QQ, Microsoft Live Messenger and SIM.

### BACKGROUND OF INVENTION

There are multiple legitimate reasons for which a party (person or organization) may be interested to retrieve from a computer the instant messages sent or received by a user.

A person may uninstall some instant message (IM) software, and then need to recover the messages without having the original IM software installed. It may also be that the software was installed again, but it lost track of the data files previously used. It may also be that the person lost the password and cannot retrieve it, so now, even if the software is installed, he cannot have access to the messages.

Messages may need to be retrieved by a parent for the purpose of parent supervision, or by a forensic investigator in the course of a legal investigation. In such a case the messages need to be recovered in the absence of a user or password available for an account.

Message files may exist on a hard disk of a computer, or in the Recycle Bin. In both cases they can be retrieved and analyzed. A number of patterns for both the file names and the file contents may be utilized in order to identify the files.

It may be that the data files containing messages were deleted and even purged from the Recycle Bin of a Windows operating system. If the data files used by the IM software were deleted and purged, some of their content may still be available on a storage device, but not in its entirety. In this case, messages need to be retrieved in the absence of complete data files.

In extreme situations, a forensic investigator may get access to a computer on which the data files for an IM product were completely destroyed, without any chance for recovery. In such a case, if the computer was not shut down, there is still a chance to recover some messages from the active memory.

While message histories may be seen in some IM software products, this is usually limited to the user that controls the account. The variety of situations described above creates the need for special software for retrieval of messages. This is the subject of this invention.

### SUMMARY OF THE INVENTION

Every IM program uses specific internal formats to store such information as users (sender or receiver) or message content. For this reason, the discovery of messages must take in account the specifics to each IM program. In order to search and discover instant messages sent or received from a computer, a list of candidate IM programs in which messages were created or received must be available. In one aspect of the invention, a method is provided for identifying IM programs installed on a computer. Alternatively, the user of the invention may be prompted with a list of supported IM programs, for which data will be retrieved.

Once a list of candidate IM programs is determined, in another aspect of the invention, a method is provided to search for data files specific to these programs. Files may be identified on a local computer, on a remote computer to which the investigator has access or from a storage device once connected to a computer. The search may be made using a number of methods: file names or certain text patterns expected in such files, using regular expressions. The search may be extended to archive files such as ZIP or RAR, or to image files such as Encase image, DD image or ISO. It can also be executed against deleted files in the Recycle Bin or against file fragments left after deletion, which are no longer registered in the file system. The search could also be executed against an image of the active memory, assuming that the user of the system did not shut down his computer after an IM session.

The method provides that the data which holds message information reside on a hard disk of the computer used to send and receive instant messages, or on a computer's active memory, or on a device on which files were saved.

In another aspect of the invention, once the messages are retrieved, they are organized and presented ordered by various criteria. In a particular implementation, they are sorted and shown in the order they were created and sent in a conversation between two users.

In another aspect of the method, the method and system provided allows for a search of “friends” defined in the configuration of the IM product, with whom the user of the IM may or may not had instant message conversations.

### BRIEF DESCRIPTION OF THE DRAWINGS

Having thus briefly described the invention, the same will become better understood from the following detailed discussion, made with reference to the accompanying drawing, wherein:

FIG. 1 is a block diagram illustrating the order in which, at the investigator's request, the message files are discovered using various methods, then they are read and displayed to the investigator.

FIG. 2 shows a user interface in which the investigator specifies which Instant Message programs are to be considered and which media is to be searched.

FIG. 3 shows how the results are displayed.

### DETAILED DESCRIPTION OF INVENTION

As previously discussed, we are providing here a practical system and method to retrieve a history of messages sent or received using an Instant Messenger program, including, but not limited to Skype, ICQ, Yahoo! Messenger, Miranda, QQ, Live Messenger and SIM. While most Instant Messenger programs allow a user to log in and view the message history, this history is only visible to the owner of the account as long as the IM program is still installed and he has the password for his account. If any of these conditions are not satisfied, he cannot normally view the history, unless he uses a system and method as described in this invention.

To build an implementation of the system described in this invention, a skilled developer needs to have particular information about each Instant Messenger program to which it applies. A list of Instant Messenger programs may be obtained, for instance, by performing a web search, looking for “Instant Messenger,” or from Wikipedia http://en.wikipedia.org/wiki/Instant_messaging. Most Instant Messenger programs are available for download and install, and they are usually free. This allows a skilled developer to gather all particular information required about a particular Instant Messenger, in order to build a system as described in this invention. The information pertaining to a particular Instant Messenger program is not part of this invention. To create an implementation of this invention, the developer must know: (1) the information written in the Windows system registry by the Instant Messenger program, which usually includes records in the HKEY_CURRENT_USER or HKEY_LOCAL_MACHINE folder, and (2) the particular way in which an instant messenger program stores messages. This can be found from various sources, including documentation or actual messages stored after the program was used. Since such information is not part of the invention, it will not be described in this document. The assumption is made that it is available by one of the means described above.

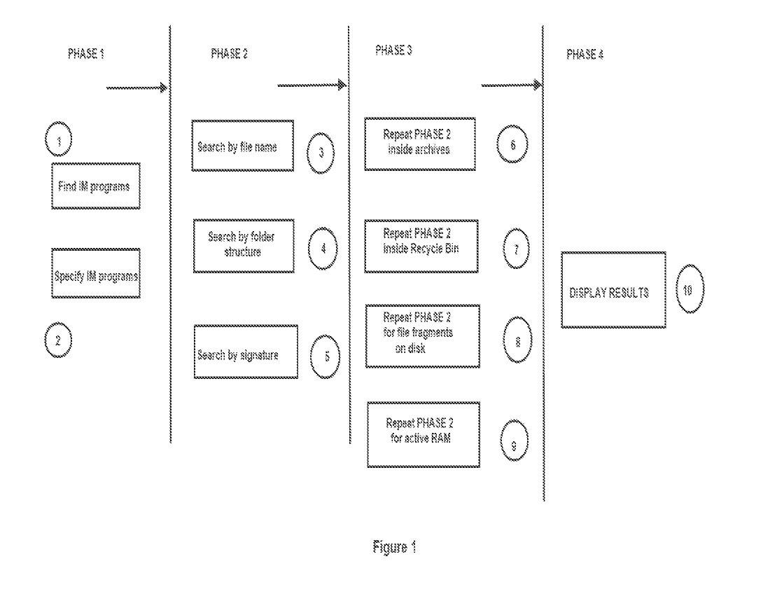

In the system that is the subject of this invention, the search for instant messages proceeds in a certain order as illustrated in FIG. 1. The process of finding and showing messages is broken in four phases. In PHASE 1, as indicated in FIG. 1, the system allows the investigator to restrict the search for instant messages to those produced by programs indicated by the investigator or found to be installed on the disk. In PHASE 2, files with messages are searched by name, directory structure or some signature found in a file. In PHASE 3 this search is extended to include archived files, deleted files in the Recycle Bin, file fragments left on a disk and active RAM. In PHASE 4 all messages found are organized and presented to the investigator.

Looking for all possible messages from all possible instant messenger programs may be time consuming. To avoid this, the system described here can reduce the “candidate list” of possible internet messenger programs considered to a restricted “found list” in two ways, as described below.

In Step 1 of FIG. 1, the investigator may request the system to find which Instant Messenger programs were installed on the computer. To determine this, a “candidate list” of the most important and commercially available Instant Messenger Programs must be known to the system described by the invention and it can be recorded in a configuration file that goes along with the system. This list is limited to those instant messenger programs for which the system was enabled, but should be otherwise as comprehensive as possible.

If the investigator wants to limit the search of messages to programs installed on the computer under scrutiny, in Step 1 the system takes each program from the “candidate list” described above and looks for a corresponding entry in the Windows Registry. If the entry specific to the program is found, it means that the program was installed on this computer. Depending on how the instant messenger program was installed, the registry entry may be in a folder like HKEY_CURRENT_USER or HKEY_LOCAL_MACHINE of the registry of the Windows operating system registry installed on the computer. Any instant messenger program found is now put on a “found list,” and from now the system will only look for files associated with programs on the “found list.”

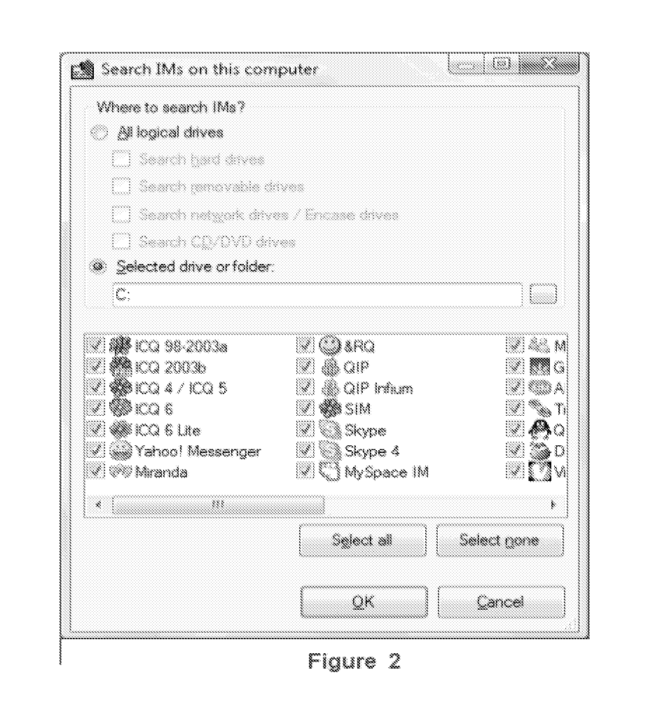

Alternatively, as indicated in Step 2 of FIG. 1, the investigator may select himself the instant messenger programs for which the system will try to find corresponding message files. In this case, the system will prompt with the investigator with the “candidate list” in some GUI window and the investigator will check those for which he intends to find messages, as in FIG. 2. The “found list” is then built based on the user selections.

Once the “found list” of Instant Messenger programs is established, all future searches for messages is restricted to those produced by programs in this list.

When the investigator requests for messages to be found, the system may look in various places for files containing messages, including: files in various folders, archive files (like .zip or .rar), deleted files (in the Recycled Bin folder), file fragments and active RAM. Permanent storage (which excludes active RAM) may exist in the form of a hard disk attached to a local computer, an external storage device or a disk on a remote computer, to which the investigator has access. Some combination of techniques could be used. For instance, if a particular search method is based on finding certain patterns in a file, it may be used for each one of the media listed above. The heuristics defined here could be combined in various ways. In a particular implementation, for example, the system may look for file names on a disk, inside an archive and in the Recycled Bin folder, or it can identify files or file fragments by certain inside patterns.

The use of heuristic methods for finding message files allows for a very flexible approach. A good implementation of this invention will use all heuristics described here, but it may work well even with less then all. The more heuristics are used, the probability of finding instant messages is increased.

In the case of some Instant Messenger programs, message files may be identified as in Step 3 of Figure, by their file names. For instance, for old versions of the ICQ program, the name may be 1234567.dat. The name (representing user UIN, i.e. user number in ICQ network) should be numeric, not less than 10000, and the extension should be .dat, and the file size should not be less than 2001 bytes. ICQ 2003 has a history file Messages1234567.fpt, The name is formed by the string “Messages” followed by the UIN; the extension is .ftp.

For other Instant Messenger programs, files may be recognized by the directory structures, as illustrated in Step 4 of FIG. 1. For instance, Yahoo! Messenger stores its history in the subdirectories like Profiles\Archive\Messages. The system will perform a search through all directories found on the computer disks, and such a structure is found, there is a very high probability that it is exactly the Yahoo! Messenger history folder.

For other Instant messenger programs, like for example Skype version 4, the history is stored in a file called main.db. This file is an SQLite database. The system described by this invention may try to open it by using SQLite API. If the open operation executes correctly and the system finds that it contains a table called “Messages”, then it is highly probable that this is a Skype 4 history file.

Some Instant Messenger programs use arbitrary file names and common extensions names for history files. For example, the Miranda history file may be called John.dat. Simply looking for the .dat extension may lead to too many false positives, if we consider all .dat files to be Miranda history files. To avoid such false positives, the system can use the method designated in Step 5 of FIG. 1, and search for a Miranda signature. In the case of Miranda, this signature consists of a first line, which should be “Miranda ICQ DB”. If a .dat file contains this signature, it is highly probable that it is a Miranda history file. This approach may also help in extreme situations, such as when a user has renamed the history file. If such a situation is suspected, the system may open each and every file searching for the Miranda signature.

The heuristics described above may be used when the history files are not regular files known to the operation system. It is possible that the user has archived them, deleted them and even purged them from the Recycled Bin folder of the Windows operation system. Special methods need to be used in every such case.

If the message files are stored in an archive file such as zip or rar, they may be discovered the same way as already described above. The search for files, designated by Step 6 of FIG. 1, will be simply extended so that if an archive file is found, its content is first extracted and then analyzed using the heuristics described above. For both rar and zip files, utilities or API exist allowing such an extraction.

Files containing instant messages may be deleted by the user, but not permanently deleted from the disk. The Windows operating system places such files in a folder called Recycle Bin and on user request can restore them to their original place. Files are stored in folders with names like L:\RECYCLER\S-1-5-21-1078081533-1897051121-1606980848-1003 or C:\$Recycle.Bin\S-1-5-21-2126067042-1242331735-38913928-1001. There is one recycle bin for each logical drive and its name depends on the version of the operating system.

The files placed in the recycle bin have different names than the ones before deletion. Apart from using a different method to find the files by name patterns, the search for messages proceeds in the same way as for regular files that were not deleted. In this case, in order to identify the original names of the files, the system uses information available from the operating system. The way in which the original names are recorded depends on the version of the operating system and the full information on this subject may be found by reading the documentation for a particular version. Since this information is public, it is not described here in detail. For Windows XP, for example, the Recycle Bin contains a file called INFO2. Its format is publicly known and described. This file contains full original paths of deleted files that are stored in the Recycle Bin. For Windows Vista and Windows 7 the format is different and is also known and published. Once the files and their names are identified in the Recycle Bin, in Step 7 of FIG. 1, the same methods as described above are used to find the message files.

In a more extreme situation, some message files may be first deleted, and then purged from the Recycle Bin. In this case the operating system has no more information about the files and the space they occupy on disk is designated as free space. If the space is not actually used by other, newer files, it may be scanned and file fragments may be retrieved for analysis, using publicly available API, such as the CreateFile function in the Windows API, which retrieves data directly from the disk (not from designated files) and presents it as if it was one contiguous file. Once these fragments are retrieved, the system looks for specific signatures of instant message files (such as, for example, “Miranda ICQ DB”). If the signature is detected, it is highly probable that the fragments in question belonged to a file containing messages. Signatures may be discovered not only for the message history file itself, but also for individual messages found in file fragments. As an example, all Skype messages are preceded by the string “1331” (referring to Skype version 3). An embodiment of this invention may use any message information that is found in order to extract maximum information about an instant messages chat session.

Once the files or file fragments are discovered as explained above, in Step 8 of FIG. 1 the system will start to identify particular messages. To accomplish this, the whole drive is read as if it was a single file, which is possible by using the Windows API. The content retrieved is scanned for message signatures. When a message signature for a particular Instant Messenger program is discovered, the system proceeds to look at its content.

The system described in this invention may also retrieve instant messages directly from the computer active memory (“active RAM”), in Step 9 of FIG. 10. If the investigator finds the computer shut down, or locked (requiring a user logon), then the active RAM content is not available. However, it the user is logged on and the system is not locked, the content of RAM can be retrieved. The investigator can run the system described by this invention from a flash drive and dump the RAM content to this drive. There are commercially available programs that allow the retrieval of the active memory in the form of a file. One such program is windd (http://www.msuiche.net/2009/10/11/windd-1-3-final-x86-and-x64/). Once the active memory used by the Instant Messenger program is available, it can be scanned by the system in order to detect messages, using specific signatures. These signatures are not the same as for deleted history on disk (because this is memory dump), and they are specific to each Instant Messenger program. For example, Yahoo messages stored in memory start with the sequence of bytes FD EF (hexadecimal display) repeated 9 times.

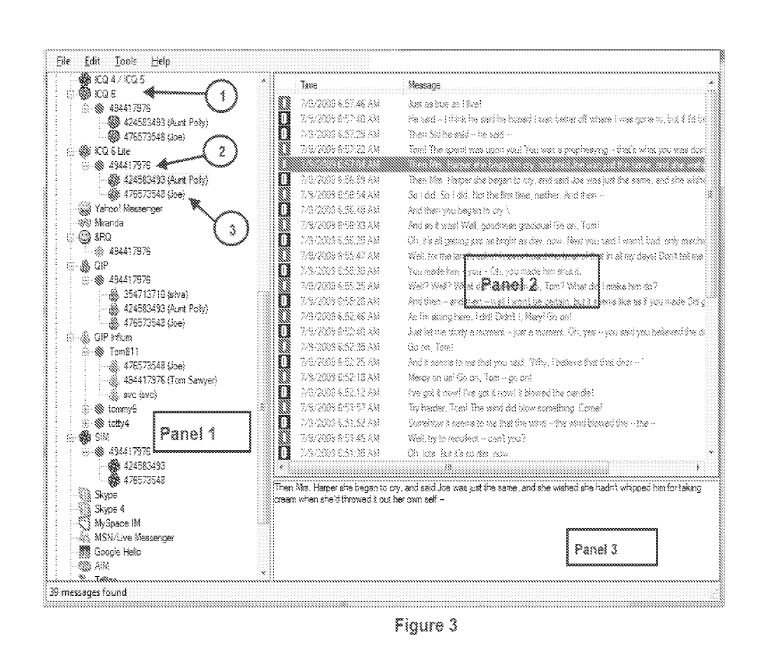

After all possible messages are retrieved, for each message the system will retrieve the sender, the receiver, the timestamp (if available) and the content of the message. In a possible implementation, a user interface can be built such that the investigator can, in Step 10 of FIG. 1, select messages by Instant Messenger program used, by sender or by receiver. The messages could be displayed in their time sequence, so that the investigator can follow the logic of a discussion between sender and receiver. A possible implementation of the user interface that offers all these features is shown in FIG. 3. There are three panes. Panel 1 shows all the instant messenger programs found. Block 1 shows such an instant Messenger program. Block 2 shows an account identified for this program. Block 3 shows conversations with another account. If the investigator selects a particular conversation, the actual messages are shown in their time sequence in Panel 2. A color or prefix is used to show which messages are sent and which are received. If the investigator selects a particular message, all its content is shown in Panel 3.

What is claimed is:

1. A method, comprising: acquiring the data related to instant messages from a local or remote computer, in the absence of an instant messenger program or user login information; acquiring such data from a storage device once connected to a computer; acquiring such data directly on the computer on which an Instant Messenger program was installed; once the data was acquired, showing all the messages sent or received by a computer user who utilized an Instant Messenger program.

2. A method of claim 1, further comprising a method to automatically identify the Instant Messenger programs installed or present a user interface in which the user selects them.

3. A method of claim 1, in which message files are discovered in the folders of a storage device.

4. A method of claim 1, in which message files are discovered in an archive file or an image file.

5. A method of claim 1, in which message files are discovered in the Recycle Bin.

6. A method of claim 1, further comprising of a way to identify the data files related to a particular Instant Messenger program by the file names or directory structures used by the Instant Messenger program.

7. A method of claim 1, further comprising of a way to identify the data files related to a particular Instant Messenger program by using particular data patterns in those files.

8. A method of claim 1, further comprising a way to discover message data from file fragments left on a storage device after the files were deleted and purged from the Recycle Bin.

9. A method of claim 1, further allowing the discovery and retrieval of messages from a copy of active memory which was recorded on a storage device by another program.

10. A method of claim 1, further comprising a user interface in which the messages sent or received are presented grouped by the Instant Messenger program utilized on the target device and by user account, and are sequenced in the order in which they were sent or received.

11. A system, comprising: a component for acquiring the data related to instant messages from a local or remote computer or from a storage device once connected to a computer, in the absence of an instant messenger program or user login information; an online interface that displays all the messages sent or received by a computer user who utilized an Instant Messenger program.

12. A system of claim 11, which automatically identifies the Instant Messenger programs installed or presents a user interface in which the user selects them.

13. A system of claim 11, in which message files are discovered in the folders of a storage device.

14. A system of claim 11, in which message files are discovered in an archive file or an image file.

15. A system of claim 11, in which message files are discovered in the Recycle Bin.

16. A system of claim 11, which discovers message data from file fragments on a storage device.

17. A system of claim 11, which discovers instant message files by their names or folder structure.

18. A system of claim 11, which discovers instant message files by patterns in their content.

19. A system of claim 11, further allowing the discovery and retrieval of messages from a copy of active memory which was recorded on a storage device by another program.

20. A system of claim 11, which presents a user interface in which the messages sent or received are displayed grouped by the Instant Messenger program utilized on the target device and by user account, and are sequenced in the order in which they were sent or received.
